(19) United States
(12) Patent Application Publication
(10) Pub. No.: US 2026/0319432 A1
(43) Pub. Date: Oct. 15, 2026

(54) COOLING DEVICE AND IMAGE FORMING APPARATUS

(71) Applicant: KYOCERA Document Solutions Inc., Osaka (JP)

(72) Inventor: Naoki SUEISHI, Osaka (JP)

(73) Assignee: KYOCERA Document Solutions Inc., Osaka (JP)

(21) Appl. No.: 19/637,862

(22) Filed: Apr. 2, 2026

(30) Foreign Application Priority Data
Apr. 14, 2025 (JP) 2025-066158

(51) Int. Cl. G03G 21/20

(52) U.S. Cl. CPC G03G 21/206

(57) ABSTRACT

A cooling device cools a cooling target member extending in a longitudinal direction and having a plurality of cooling requiring portions separated from each other. The cooling device includes a housing, a suction fan, one suction fan, and a piping structure. The housing houses the cooling target member. The suction fan takes outside air into the housing. The piping structure circulates the air from the suction fan toward the cooling target member. The piping structure has a plurality of ducts which communicate an exhaust side of the suction fan with the plurality of cooling requiring portions.

### INCORPORATION BY REFERENCE

This application is based on and claims the benefit of priority from Japanese patent application No. 2025-066158 filed on Apr. 14, 2025 which is incorporated by reference in its entirety.

### BACKGROUND

The present disclosure relates to a cooling device which cools a cooling target member and an image forming apparatus.

In an image forming apparatus, a configuration for cooling a plurality of cooling requiring portions (CPU, polygon motor and fixing part) in the apparatus is known. For example, a duct for circulating air from an intake port on the right side surface toward an exhaust port on the left side surface is provided inside the apparatus. The plurality of cooling requiring portions are arranged in order from the upstream to the downstream in the air flow direction. The duct is provided with a plurality of air intake openings so as to correspond to the plurality of cooling requiring portions. When a fan generates the air flow from the intake port to the exhaust port, the air (air flow) is branched at the plurality of air intake openings to air-cool the plurality of cooling requiring portions.

### SUMMARY

A cooling device according to the present disclosure cools a cooling target member extending in a longitudinal direction and having a plurality of cooling requiring portions separated from each other. The cooling device includes a housing, one suction fan, and a piping structure. The housing houses the cooling target member. The suction fan takes outside air into the housing. The piping structure circulates the air from the suction fan toward the cooling target member. The piping structure has a plurality of ducts which communicate an exhaust side of the suction fan with the plurality of cooling requiring portions.

An image forming apparatus according to the present disclosure includes the cooling device.

The above and other objects, features, and advantages of the present disclosure will become more apparent from the following description when taken in conjunction with the accompanying drawings in which a preferred embodiment of the present disclosure is shown by way of illustrative example.

### BRIEF DESCRIPTION OF THE DRAWINGS

FIG. 1 is a perspective view showing an image forming apparatus according to one embodiment of the present disclosure.

FIG. 2 is a cross-sectional view taken along the line II-II of FIG. 1.

FIG. 3 is a cross-sectional view taken along the line III-III of FIG. 1.

FIG. 4 is a cross-sectional view showing a state in which a suction fan and a power supply cover are removed from FIG. 3.

FIG. 5 is a cross-sectional view taken along the line V-V of FIG. 2.

### DETAILED DESCRIPTION

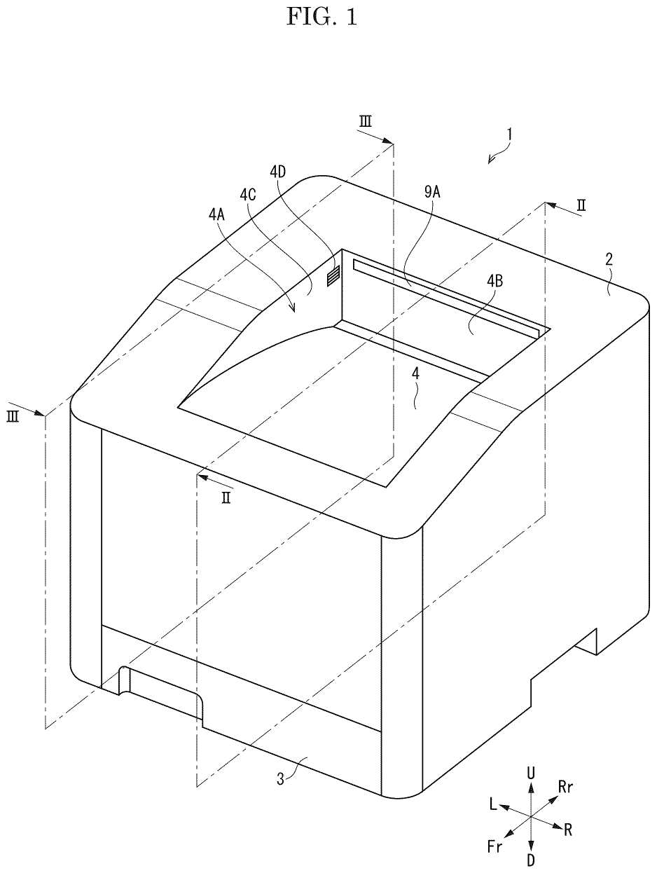

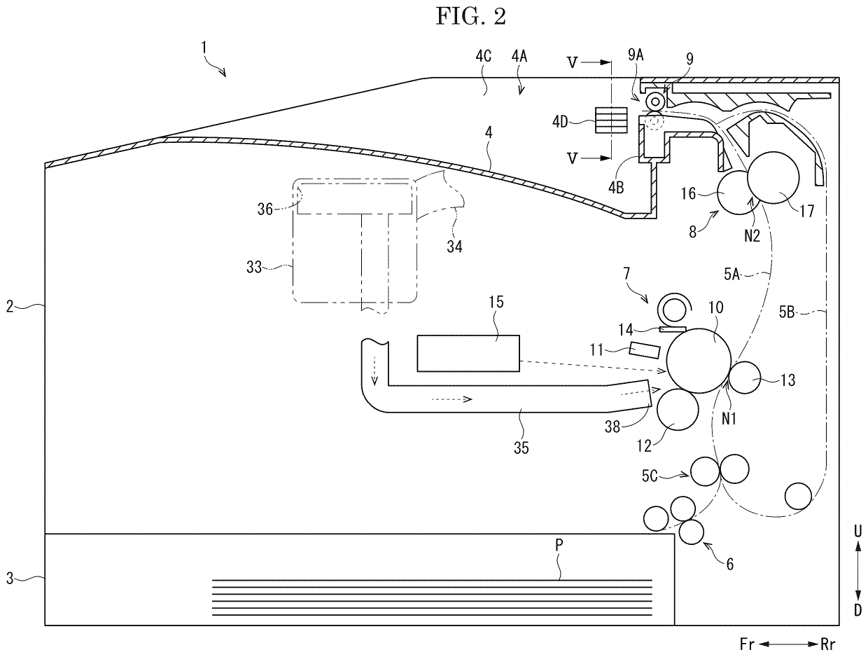

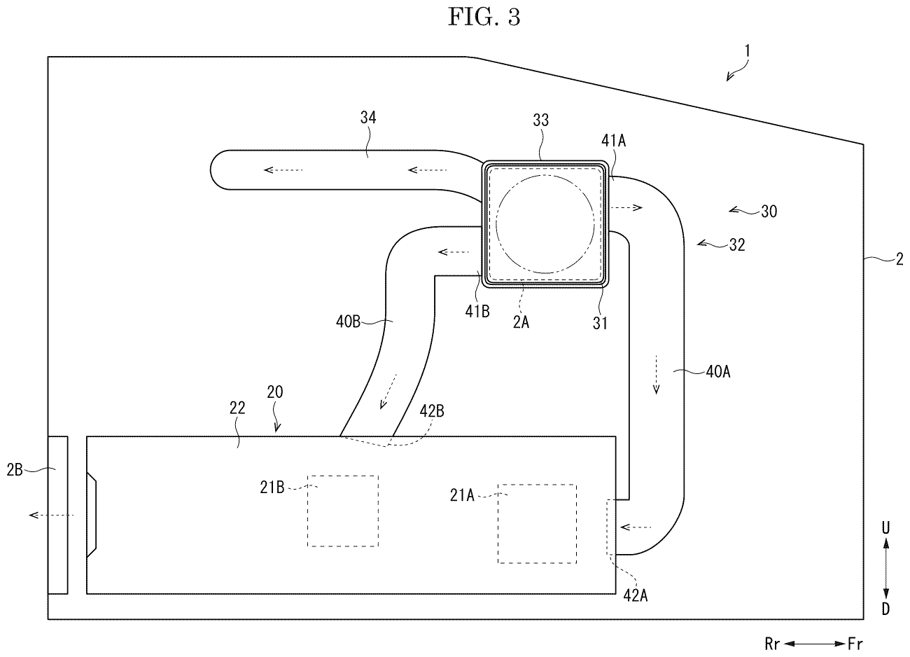

Hereinafter, with reference to the attached drawings, one embodiment of the present disclosure will be described. Fr, Rr, L, R, U, and D in the drawings indicate the front, rear, left, right, upper, and down. The front-and-rear direction (longitudinal direction, media discharge direction), the left-and-right direction (width direction), and the upper-and-down direction are orthogonal to each other. Although the terms indicating the direction and position are used in the specification, these terms are for convenience of description and are not intended to limit the scope of the disclosure. In the drawings, the shapes, dimensions, angles, positions, and the like of the constituent members are not necessarily accurate and are schematized for the purpose of explanation.

[Image Forming Apparatus] With reference to FIG. 1 to FIG. 3, the image forming apparatus 1 will be described. FIG. 1 is a perspective view showing the image forming apparatus 1. FIG. 2 is a cross-sectional view taken along the line II-II of FIG. 1. FIG. 3 is a cross-sectional view taken along the line III-III of FIG. 1.

The image forming apparatus 1 is a printer which forms an image by transferring a toner image formed by an electrophotographic method to a paper P (medium). As shown in FIG. 1, the image forming apparatus 1 includes a housing 2 having a substantially rectangular parallelepiped appearance. In the lower portion of the housing, a paper feeding cassette 3 which stores the paper P is detachably provided. A discharge tray 4 to which the paper P is discharged is provided on the upper portion of the housing 2. The housing 2 includes a metal frame and a synthetic resin member fixed to the frame. The paper P as an example of the medium is not limited to a paper sheet, but may be a sheet made of resin or the like.

The discharge tray 4 constitutes a bottom surface of a discharge recess 4A formed by largely recessing the central region of the upper surface of the housing 2. The discharge tray 4 is inclined downward while curving from the front side to the rear side of the upper surface of the housing 2 (see also FIG. 2). A discharge opening surface 4B is formed between the rear end of the discharge tray 4 and the upper surface of the housing 2, and a pair of right and left discharge side surfaces 4C are formed between the right and left ends of the discharge tray 4 and the upper surface of the housing 2. The discharge opening surface 4B and the respective discharge side surfaces 4C are erected surfaces constituting the discharge recess 4A. The discharge recess 4A (discharge tray 4, discharge opening surface 4B and respective discharge side surfaces 4C) constitutes a part of the housing 2. A discharge port 9A is formed on the upper portion of the discharge opening surface 4B, and a pair of discharge rollers 9 (see FIG. 2) is arranged inside the housing 2 and near the discharge port 9A. The pair of discharge rollers 9 as an example of the discharge device rotates while holding the paper P, and discharges the paper P through the discharge port 9A toward the discharge tray 4. An air blowing port 4D for blowing air from the left side to the right side along the outside of the discharge port 9A (the direction in which the discharge port 9A extends) is provided on the upper portion of the left discharge side surface 4C (see also FIG. 2).

As shown in FIG. 2, a conveying path 5A serving as a path along which the paper P is conveyed from the paper feeding cassette 3 to the discharge tray 4 is formed inside the housing 2. The conveying path 5A is formed in a substantially S-shape from the rear and lower portion to the rear and upper portion of the housing 2. In the rear portion of the housing 2, an inversion conveying path 5B, which branches at the downstream side portion (upper portion) of the conveying path 5A and merges with the upstream side portion (lower portion) of the conveying path 5A, is provided. A feeding device 6 which feeds the paper P stored in the paper feeding cassette 3 to the conveying path 5A is provided at the upstream end portion of the conveying path 5A (near the feeding cassette 3). On the downstream side of the paper feeding device 6 on the conveying path 5A, a pair of registration rollers 5C for temporarily blocking the paper P to be conveyed and correcting the inclination of the paper P (skew correction) is provided.

As shown in FIG. 2, an image forming device 7 and a fixing device 8 are provided inside the housing 2. The image forming device 7 is provided on the downstream side of the paper feeding device 6 on the conveying path 5A, and forms a toner image on the paper P to be conveyed. The fixing device 8 is provided on the downstream side of the image forming device 7 on the conveying path 5A (on the rear and lower side of the pair of discharge rollers 9), and thermally fixes the toner image on the paper P.

<Image Forming Device> The image forming device 7 includes a photosensitive drum 10, a charging device 11, a developing device 12, a transfer roller 13, a cleaning device 14, and an optical scanning device 15. The photosensitive drum 10 is formed in a substantially cylindrical shape elongated in the left-and-right direction, and is driven by a motor (not shown) to rotate around an axis (in the counterclockwise direction in FIG. 2). The charging device 11, the developing device 12, the transfer roller 13, and the cleaning device 14 are arranged around the photosensitive drum 10 in the order of the image forming process. The transfer roller 13 is in contact with the photosensitive drum 10 and forms a transfer region N1 between the photosensitive drum 10 and the transfer roller 13. Although not shown, a toner container housing the replenishing toner (developer) is detachably provided in the housing 2. The toner container is connected to the developing device 12 via a supply pipe, and supplies the toner to the developing device 12.

<Fixing Device> The fixing device 8 includes a heating belt 16 and a pressure roller 17. The heating belt 16 as an example of the heating member is made of material having flexibility and is formed in a substantially cylindrical shape elongated in the left-and-right direction. A heater (not shown) for heating the heating belt 16 is provided in the hollow portion of the heating belt 16. The heater may be, for example, a halogen lamp or a heating substrate having a heating resistor. The pressure roller 17 as an example of the pressure member is formed in a substantially cylindrical shape elongated in the left-and-right direction, and forms a pressurizing region N2 between the pressure roller 17 and the heating belt 16. The pressure roller 17 is driven by a motor (not shown) to rotate around an axis, and the heating belt 16 rotates following the rotation of the pressure roller 17.

<Power Supply Part> As shown in FIG. 3, a power supply part 20 for supplying power to various devices is disposed in the housing 2 (in the lower and left portion). The power supply part 20 includes, for example, a power circuit for generating power suitable for the operation of the image forming apparatus 1 from power supplied from a commercial power source. The power supply part 20 extends, for example, in the front-and-rear direction (the longitudinal direction, the horizontal direction) along the lower portion of the left side surface of the housing 2. The dimension of the power supply part 20 in the front-and-rear direction is shorter than the dimension of the housing 2 in the front-and-rear direction, and the power supply part 20 is arranged at the rear portion in the housing 2. The height of the power supply part 20 is set sufficiently shorter (lower) than the minimum height of the housing 2. By extending the power supply part 20 in the front-and-rear direction (horizontal direction) in the lower portion of the housing 2, the height dimension of the power supply part 20 can be reduced and the height of the housing 2 can be reduced. Thus, the entire image forming apparatus 1 can be miniaturized.

A metal power supply cover 22 is attached to the left side of the power supply part 20. The power supply cover 22 covers electric components mounted on the board of the power circuit and blocks noise such as electromagnetic waves. An exhaust opening portion 2B is provided on the lower and left portion of the rear surface of the housing 2, and the rear end of the power supply part 20 faces the inside of the exhaust opening portion 2B.

[Image Forming Process] The operation of the image forming apparatus 1 will now be described. A control device (not shown) for integrally controlling the image forming apparatus 1 executes image forming process (control) based on image data input from an external terminal, for example, as follows.

The charging device 11 charges the surface of the photosensitive drum 10. The optical scanning device 15 emits scanning light toward the photosensitive drum 10 to form an electrostatic latent image corresponding to the image data on the surface of the photosensitive drum 10. The developing device 12 develops the electrostatic latent image on the photosensitive drum 10 into a toner image by using the toner supplied from the toner container. The paper feeding device 6 separates the papers P in the paper feeding cassette 3 one by one and feeds them to the conveying path 5A. The paper P is conveyed along the conveying path 5A and the skew is corrected by the pair of registration rollers 5C. The transfer roller 13 transfers the toner image on the photosensitive drum 10 to the surface of the paper P passing through the transfer region N1. Thereafter, the cleaning device 14 removes the toner remaining on the photosensitive drum 10. The fixing device 8 thermally fixes the toner image on the paper P passing through the pressurizing region N2 between the heating belt 16 and the pressure roller 17 (fixing operation). In the case of single-sided printing, the pair of discharge rollers 9 discharges the paper P passing through the pressurizing region N2 from the discharge port 9A toward the discharge tray 4.

In the case of double-sided printing, the paper P passing through the fixing device 8 is switched back at the downstream side of the conveying path 5A and fed to the inversion conveying path 5B. The paper P is returned from the inversion conveying path 5B to the conveying path 5A again, and is sent to the transfer region N1 after being the skew corrected by the pair of registration rollers 5C. Thereafter, the toner image is transferred to the paper P, thermally fixed, and the double-sided printed paper P is discharged to the discharge tray 4.

Incidentally, the image forming device 7 (such as the photosensitive drum 10 and the developing device 12) and the power supply part 20 generate heat in association with the execution of the above-described image forming process. For example, a plurality of electric components such as a transformer, a diode, a triac, and a field-effect transistor which generates heat by being driven are mounted on the power supply part 20. The power supply part 20 is also provided with a heat sink or the like for discharging the heat of the component generating heat to a space. In the power supply part 20 according to the present embodiment, as an example, the components that generate heat are arranged concentratedly at two locations separated in the front-and-rear direction. That is, the power supply part 20 has two cooling requiring portions 21A and 21B that require cooling at positions separated from each other in the front-and-rear direction (see FIG. 3). Therefore, the image forming apparatus 1 according to the present embodiment is provided with a cooling device 30 which cools the member that generates heat. Incidentally, in the present specification, the image forming device 7, the power supply part 20, and the like are sometimes referred to as “the cooling target member”. In the present specification, for the sake of convenience of description, only arithmetic numerals are added to the reference numerals in the description common to the two cooling requiring portions 21A and 21B.

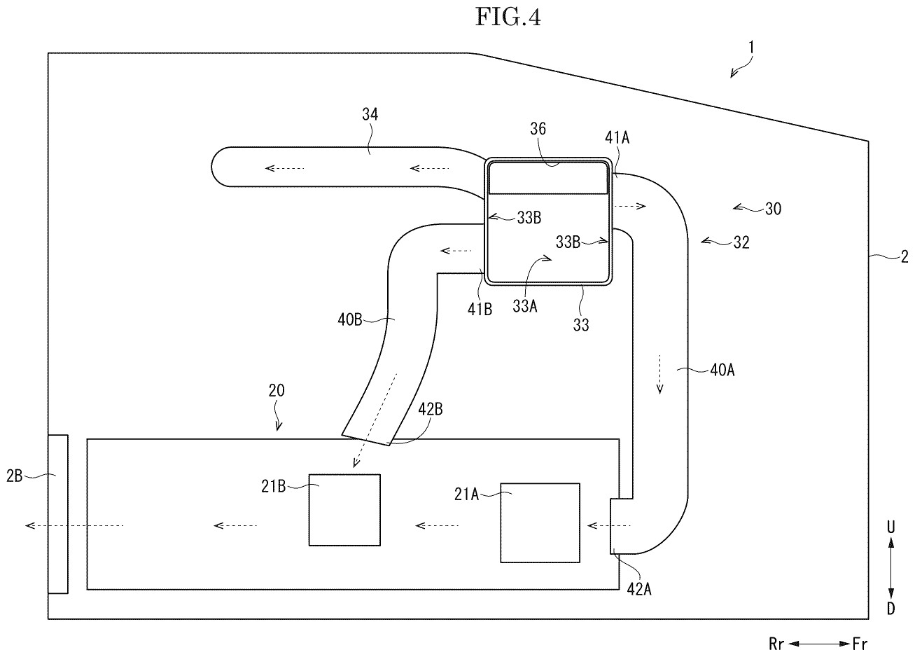

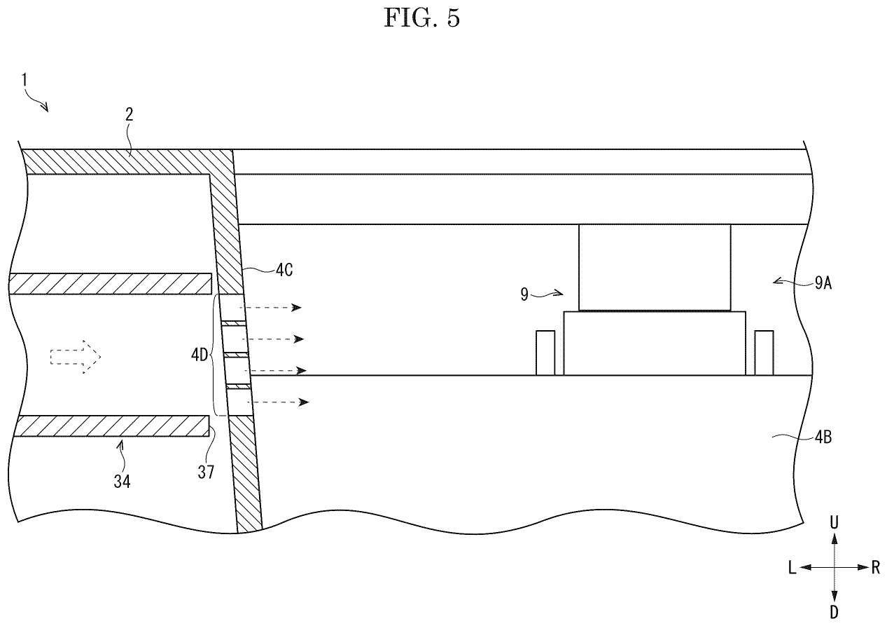

In addition, when the paper P containing a large amount of moisture (high moisture content) is used for the image formation, water vapor may be generated from the paper P during the thermal fixing in the fixing device 8. When the water vapor generated from the paper P flows out through the discharge port 9A, the user may misunderstand that smoke is emitted. Therefore, in the image forming apparatus 1 according to the present embodiment, the cooling device 30 which cools the member that generates heat is also used in order to suppress erroneous recognition of smoke generation due to the outflow of water vapor.

[Cooling Device] With reference to FIG. 2 to FIG. 5. The cooling device 30 will be described. FIG. 4 is a cross-sectional view showing a state in which a suction fan 31 and a power supply cover 22 are removed from FIG. 3. FIG. 5 is a cross-sectional view taken along the line V-V of FIG. 2.

As shown in FIG. 3, the cooling device 30 includes the housing 2 housing the cooling target member such as the power supply part 20, a suction fan 31 for taking outside air into the housing 2, and a piping structure 32 for circulating air from the suction fan 31 toward the cooling target member. The housing 2 is a component of the image forming apparatus 1 and also a component of the cooling device 30. In the following description, the terms “upstream” and “downstream” refer to the upstream and downstream of the direction in which air flows (the direction in which air flows).

<Suction Fan> As shown in FIG. 3, the suction fan 31 is provided, for example, on the upper portion of the left side surface of the housing 2. The suction fan 31 is, for example, an axial flow fan for generating air flow from one side (the left side) to the other side (the right side) in the axial direction by rotating a blade around an axis. The suction fan 31 is electrically connected to the power supply part 20 and the control device, and is driven under the control of the control device. Incidentally, the suction fan 31 is not limited to an axial flow fan, and may be another type of fan such as a centrifugal fan or a sirocco fan.

<Piping Structure> As shown in FIG. 2 and FIG. 3, the piping structure 32 includes a fan holding part 33, an air blowing duct 34, a first duct 35, and two second ducts 40A and 40B. The piping structure 32 (fan holding part 33, air blowing duct 34, and first to second ducts 35, 40A and 40B) is molded by using, for example, heat-resistant synthetic resin, and is provided inside the housing 2. In this specification, for the sake of convenience of description, only arithmetic numerals are attached for the common description of the two second ducts 40A and 40B (the same applies to second inflow ports 41A and 41B and second outflow ports 42A and 42B, which will be described later).

(Fan Holding Part) As shown in FIG. 3, an intake opening portion 2A is provided on the upper portion of the left side surface (on the front side of the paper plane of FIG. 3) and substantially at the center in the front-and-rear direction of the housing 2, and the fan holding part 33 is provided so as to face the inside of the intake opening portion 2A. The fan holding part 33 holds the suction fan 31 in a posture with the intake side (left side) facing the intake opening portion 2A. A space (not shown) is formed between the right side surface 33A of the fan holding part 33 (see FIG. 4) and the suction fan 31. That is, the exhaust side (right side) of the suction fan 31 faces the right side surface 33A of the fan holding part 33 via the space.

As shown in FIG. 4, a common inflow port 36 for the air blowing duct 34 and the first duct 35 is opened on the upper portion of the right side surface 33A of the fan holding part 33. Further, the second inflow ports 41A and 41B of the two second ducts 40A and 40B are opened on both side surfaces 33B of the fan holding part 33 constituting the space. Filters for removing dust and the like are attached to the outside of the intake opening portion 2A and the exhaust opening portion 2B of the housing 2 (not shown).

(Air Blowing Duct, First Duct) The air blowing duct 34 and the first duct 35 are conduits for circulating the air flow (air) generated by driving the suction fan 31. The upstream ends of the air blowing duct 34 and the first duct 35 are integrally formed to form one common inflow port 36 (see FIG. 4). The air blowing duct 34 branches from the first duct 35 and extends rearward (see FIG. 3 and FIG. 4), and the downstream end (the air blowing outflow port 37) of the air blowing duct 34 faces the air blowing port 4D formed on the left discharge side surface 4C (see FIG. 5). That is, the air blowing duct 34 communicates the exhaust side of the suction fan 31 with the air blowing port 4D. The first duct 35 branches from the air blowing duct 34, extends generally downward and rightward, and then extends rearward toward the vicinity of the image forming device 7 (see FIG. 2). The downstream end portion (the first outflow port 38) of the first duct 35 faces the image forming device 7 (such as the photosensitive drum 10 and the developing apparatus 12) (see FIG. 2). That is, the first duct 35 communicates the exhaust side of the suction fan 31 with the image forming device 7.

(Second Duct) The second duct 40, like the first duct 35 and the like, is a conduit for circulating air. As shown in FIG. 3 and FIG. 4, the two second ducts 40A and 40B communicate the exhaust side of one suction fan 31 with the two cooling requiring portions 21A and 21B. A specific description will be given below.

As shown in FIG. 4, the second inflow port 41A formed at the upstream end of one second duct 40A is connected (opened) to the front side surface 33B of the fan holding part 33. One second duct 40A extends downward (substantially vertically downward) from the fan holding part 33, and the downstream end portion (the second outflow port 42A) of the second duct 40A faces the front cooling requiring portion 21A disposed in the front portion of the power supply part 20. In other words, the second outflow port 42A of the second duct 40A is disposed so as to face the exhaust opening portion 2B via the power supply part 20.

The second inflow port 41B formed at the upstream end of the other second duct 40B is connected (opened) to the rear side surface 33B of the fan holding part 33. The other second duct 40B extends substantially downward from the fan holding part 33, and the downstream end portion (the second outflow port 42B) of the other second duct 40B faces the upper portion of the cooling requiring portion 21B disposed in the rear portion of the power supply part 20. More specifically, the other second duct 40B is in an inclined posture slightly rearward from the upper side to the lower side, and is disposed to blow out air from the second outflow port 42B in the diagonally rearward direction. In other words, the other second duct 40B is inclined so as to face the second outflow port 42B toward the exhaust opening portion 2B.

[Operation of Cooling Device] Next, with reference to FIG. 2 to FIG. 5, the operation (function) of the cooling device 30 will be described.

When the suction fan 31 is driven, outside air is sucked through the intake opening portion 2A, passes through the suction fan 31 from the intake side toward the exhaust side, and flows into the space of the fan holding part 33. The air fed from the suction fan 31 flows into the air blowing duct 34 and the first duct 35 from the common inflow port 36, and flows into the two second ducts 40A and 40B through the two second inflow ports 41A and 41B (see the broken line arrows shown in FIG. 3 and FIG. 4).

As shown in FIG. 5, the air (air flow) flowing in the air blowing duct 34 blows out rightward through the air blowing outflow port 37 and the air blowing port 4D, and cools and diffuses the water vapor flowing out through the discharge port 9A. As a result, the water vapor changes to water, the water vapor spreads to the outside space, and the concentration of the water vapor decreases, so that the user is prevented from visually observing the water vapor.

As shown in FIG. 2, the air (air flow) flowing in the first duct 35 is blown out through the first outflow port 38 toward the image forming device 7 to cool the image forming device 7 (such as the photosensitive drum 10 and the developing device 12).

As shown in FIG. 3 and FIG. 4, the air (air flow) flowing in the second ducts 40A and 40B flows out through the second outflow ports 42A and 42B toward the corresponding cooling requiring portions 21A and 21B. More specifically, the air flowing in one second duct 40A blows out rearward through the second outflow port 42A and cools the cooling requiring portion 21A disposed in the front portion of the power supply part 20. The air flowing in the other second duct 40B blows downward through the second outflow port 42B to cool the cooling requiring portion 21B disposed in the rear portion of the power supply part 20. In this way, the second outflow ports 42A and 42B of the two second ducts 40A and 40B allow air to flow out toward the cooling requiring portions 21A and 21B from different directions.

The air blown out through the second outflow port 42A flows rearward while cooling the cooling requiring portion 21A, and is exhausted to the outside through the exhaust opening portion 2B. The air blown out from the second outflow port 42B flows in the diagonally rearward and downward direction while cooling the cooling requiring portion 21B, and is exhausted to the outside through the exhaust opening portion 2B together with the air blown out through the second outflow port 42A.

In the cooling device 30 according to the present embodiment described above, the two second ducts 40A and 40B communicate the exhaust side of one suction fan 31 with the two cooling requiring portions 21A and 21B. According to this configuration, since one second duct 40 is provided for one cooling requiring portion 21 of the power supply part 20, the flow rate of the air flowing in each second duct 40 does not decrease toward the downstream in the flow direction, and the air of a substantially uniform flow rate can be supplied to each cooling requiring portion 21. Further, for example, since the air flowing in the second duct 40 corresponding to one cooling requiring portion 21A is not warmed by the heat generated from the other cooling requiring portion 21B, the temperature rise of the air supplied to each cooling requiring portion 21 can be suppressed. Thus, the two cooling requiring portions 21A and 21B can be properly and substantially uniformly cooled.

In the cooling device 30 according to the present embodiment, the second outflow ports 42A and 42B of the two second ducts 40A and 40B are configured to allow air to flow out toward the cooling requiring portions 21A and 21B from different directions. According to this configuration, for example, it is possible to prevent the air blown to one cooling requiring portion 21A and used for cooling the cooling requiring portion 21A to be warmed from being used for cooling the other cooling requiring portion. Therefore, the cooling requiring portions 21 can be efficiently cooled by the air flowing out from the corresponding second duct 40 (second outflow port 42).

In the image forming apparatus 1 according to the present embodiment, in addition to cooling the plurality of cooling target members (the plurality of cooling requiring portions 21) by using one suction fan 31, water vapor generated from the paper P passing through the fixing device 8 and flowing out through the discharge port 9A is cooled and diffused. According to this configuration, one suction fan 31 can be used both for cooling the plurality of cooling requiring portions 21 and for the water vapor countermeasure. As a result, the structure of the image forming apparatus 1 and the cooling device 30 can be simplified, the manufacturing cost can be reduced, and the apparatus and the device can be miniaturized as compared with the case where the fan for cooling the cooling requiring portion 21 and the fan for the above-mentioned water vapor countermeasures are provided separately.

In the cooling device 30 according to the present embodiment, the power supply part 20 (the cooling target member) includes the two cooling requiring portions 21A and 21B, and the two second ducts 40A and 40B are provided correspondingly thereto, but the present disclosure is not limited thereto. The power supply part 20 (the cooling target member) may have three or more cooling requiring portions 21 and three or more second ducts 40 may be provided corresponding to the three or more cooling requiring portions 21 (not shown).

Although the cooling device 30 according to the present embodiment cools the image forming device 7 (such as the photosensitive drum 10 and the developing apparatus 12) in addition to the power supply part 20 (the cooling requiring portions 21), the present disclosure is not limited thereto. For example, the cooling device 30 may cool the fixing device 8 in addition to the image forming device 7 and the power supply part 20 (not shown). In this case, it is preferable to provide a duct (not shown) for communicating the suction fan 31 with the fixing device 8. Further, the cooling device 30 needs only to be able to cool at least the power supply part 20 (the cooling requiring portion 21) (not shown). In this case, another cooling means for cooling the image forming device 7 and the like may be provided (not shown). Further, although the cooling device 30 according to the present embodiment is also used as the water vapor countermeasure, it is not limited to this, and may be used only for cooling the power supply part 20 (the cooling requiring portion 21) (not shown). In this case, the water vapor countermeasure may be provided with another air blowing means or may be omitted (neither of which is shown).

In the cooling device 30 according to the present embodiment, the power supply part 20 extends in the front-and-rear direction in the lower and left portion of the housing 2, but the present disclosure is not limited to this. For example, the power supply part 20 may extend in the front-and-rear direction in the lower and right portion in the housing 2, or may extend in the left-and-right direction in the lower and front portion or the lower and rear portion in the housing 2 (neither of which is shown). In addition, for example, the power supply part 20 may extend in the front-and-rear direction or the left-and-right direction in the upper portion in the housing 2, or may extend in the upper-and-down direction in an arbitrary portion in the housing 2 (neither of which is shown). Since the power supply part 20 is a relatively heavy member among the members constituting the image forming apparatus 1, it is preferable to provide it in the lower portion of the housing 2.

Further, in the description of the present embodiment, a case where the present disclosure is applied to a printer is shown as an example, but the present disclosure is not limited to this, and the present disclosure may be applied to a multifunctional peripheral, a copying machine, a facsimile machine, or the like.

It should be noted that the description of the above embodiments shows one aspect of the cooling apparatus and the image forming apparatus according to the present disclosure, and the technical scope of the present disclosure is not limited to the above embodiments. The disclosure may be variously modified, substituted, or modified without departing from the spirit of the technical idea, and the claims include all embodiments that may fall within the scope of the technical idea.

### Appendix 1

A cooling device according to Appendix 1 is a cooling device for cooling a cooling target member extending in a longitudinal direction and having a plurality of cooling requiring portions separated from each other, and the cooling device includes:
a housing which houses the cooling target member;
a suction fan which takes outside air into the housing; and
a piping structure which circulates the air from the suction fan toward the cooling target member, wherein
the piping structure includes a plurality of ducts which communicate an exhaust side of the suction fan with the plurality of cooling requiring portions.

### Appendix 2

The cooling device according to Appendix 2 is the cooling device according to Appendix 1, wherein each of the duct includes:
an inflow port through which air fed from the suction fan flows; and
an outflow port through which the air flows out toward the corresponding cooling requiring portion, wherein
the outflow ports of the plurality of ducts allow the air to flow out toward the cooling requiring portion from directions different from each other.

### Appendix 3

The cooling device according to Appendix 3 is the cooling device according to Appendix 1 or 2, and includes:
one exhaust opening portion through which air flowing out from the outflow ports of the ducts toward the cooling requiring portions is exhausted to an outside.

### Appendix 4

An image forming apparatus according to Appendix 4 includes the cooling device according to any one of Appendixes 1 to 3.

### Appendix 5

The image forming apparatus according to Appendix 5 5 is the image forming apparatus according to Appendix 4, wherein
the cooling target member is a power supply part disposed in a lower portion of the housing and extending in a horizontal direction as the longitudinal direction.

### Appendix 6

The image forming apparatus according to Appendix 6 is the image forming apparatus according to Appendix 4 or 5, and includes:
an image forming device which forms a toner image on a medium;
a fixing device which thermally fixes the toner image to the medium passing through a pressurizing region between a heating member and a pressure member; and
a discharge device which discharges the medium passed through the pressurizing region through a discharge port provided in an upper portion of the housing toward a discharge tray, wherein
the piping structure further includes an air blowing duct for communicating the exhaust side of the suction fan with an air blowing port provided at an upper portion of the housing, and
the air blowing port blows air along an outside of the discharge port from one side toward the other side in a width direction orthogonal to a discharge direction of the medium.

What is claimed is:

1. A cooling device for cooling a cooling target member extending in a longitudinal direction and having a plurality of cooling requiring portions separated from each other, the cooling device comprising:
a housing which houses the cooling target member;
a suction fan which takes outside air into the housing; and
a piping structure which circulates the air from the suction fan toward the cooling target member, wherein
the piping structure includes a plurality of ducts which communicate an exhaust side of the suction fan with the plurality of cooling requiring portions.

2. The cooling device according to claim 1, wherein each of the duct includes:
an inflow port through which air fed from the suction fan flows; and
an outflow port through which the air flows out toward the corresponding cooling requiring portion, wherein
the outflow ports of the plurality of ducts allow the air to flow out toward the cooling requiring portion from directions different from each other.

3. The cooling device according to claim 2, comprising:
one exhaust opening portion through which air flowing out from the outflow ports of the ducts toward the cooling requiring portions is exhausted to an outside.

4. An image forming apparatus comprising:
the cooling device according to claim 1.

5. The image forming apparatus according to claim 4, wherein
the cooling target member is a power supply part disposed in a lower portion of the housing and extending in a horizontal direction as the longitudinal direction.

6. The image forming apparatus according to claim 4, comprising:
an image forming device which forms a toner image on a medium;
a fixing device which thermally fixes the toner image to the medium passing through a pressurizing region between a heating member and a pressure member; and
a discharge device which discharges the medium passed through the pressurizing region through a discharge port provided in an upper portion of the housing toward a discharge tray, wherein
the piping structure further includes an air blowing duct for communicating the exhaust side of the suction fan with an air blowing port provided at an upper portion of the housing, and
the air blowing port blows air along an outside of the discharge port from one side toward the other side in a width direction orthogonal to a discharge direction of the medium.
